(19) United States
(12) Patent Application Publication
(10) Pub. No.: US 2026/0356368 A1
(43) Pub. Date: Nov. 12, 2026

(54) Driving Assistance System and Driving Assistance Method for a Vehicle

(71) Applicant: Bayerische Motoren Werke Aktiengesellschaft, Muenchen (DE)

(72) Inventors: Jannick PFORT, Fahrenzhause (DE); Soeren UNGERMANN, Muenchen (DE)

(21) Appl. No.: 19/475,209

(22) PCT Filed: Apr. 15, 2024
(86) PCT No.: PCT/EP2024/060129

§ 371 Date: Oct. 14, 2025

(30) Foreign Application Priority Data
Apr. 27, 2023 (DE) 10 2023 110 964.2

(51) Int. Cl. B60W 30/18; B60W 10/20; B60W 30/12; B60W 50/14; B60W 50/16

(52) U.S. Cl. CPC B60W 30/18163; B60W 10/20; B60W 30/12; B60W 50/16; B60W 2050/143; B60W 2050/146; B60W 2540/20; B60W 2552/10; B60W 2552/53; B60W 2710/207

(57) ABSTRACT

A driving assistance system for a vehicle includes a detection that detects a driver initiated lane change. A surroundings sensor system captures environment data depicting a region surrounding the vehicle. An analysis module analyzes the surroundings data to detect bifurcations of a roadway marking ahead of and/or behind the vehicle. The analysis module categorizes the detected lane change as intended or unintended based on detecting the presence of at least one bifurcation. A control module controls at least one vehicle function based on the categorization of the detected lane change.

### BACKGROUND AND SUMMARY

The present disclosure relates to a driving assistance system for a vehicle, to a vehicle having a driving assistance system of this type, to a driving assistance method for a vehicle, and to a storage medium for executing the driving assistance method. In particular, the present disclosure relates to a distinction between intentional lane changes and unintentional lane changes.

Driving assistance systems are assuming increasing significance. One example of a driving assistance system is a lane departure warning system, which supports the vehicle driver in preventing the departure of the vehicle from the ego-lane. To this end, the driving assistance system captures a lane trajectory and optional further parameters such as, for example, a vehicle speed, a steering angle and an indicator activation. In the event of the departure of the vehicle from the ego-lane, e.g. in the absence of an indicator activation, the lane departure warning system generates a warning for the attention of the driver and/or intervenes directly in the control of the vehicle by means of an active steering intervention, in order to maintain the vehicle in the ego-lane. It can occur that the driver and the lane departure warning system are working in mutual opposition, which opposition can be inconvenient for the driver and, in the event of cumulative occurrence, can lead to the switch-off of the system and consequent risks in traffic.

One object of the present disclosure is the specification of a driving assistance system for a vehicle, a vehicle having a driving assistance system of this type, a driving assistance method for a vehicle and a storage medium for executing the driving assistance method which enable an improvement of the reliability of the driving assistance system, in particular of a lane departure warning system. A further object of the present disclosure is an enhancement of road traffic safety, wherein the driver is not incited to switch off the system on the grounds of unwanted interventions.

According to at least one embodiment, a driving assistance system for a vehicle, in particular for a motor vehicle, is disclosed. The driving assistance system comprises a detection module which is designed to detect a driver-initiated lane change; an environmental sensor system which is designed to capture environmental data, wherein environmental data depict an environment of the vehicle; an analysis module which is designed to analyze environmental data in order to detect bifurcations in a carriageway marking ahead of and/or to rear of the vehicle, wherein the analysis module is further designed, on the basis of the presence of at least one bifurcation in a carriageway marking ahead of and/or to the rear of the vehicle, to execute a categorization of the lane change thus detected as an intentional (or conscious) lane change, or as an unintentional (or unconscious) lane change; and at least one control module which is designed to actuate at least one vehicle function on the basis of the categorization of the lane change thus detected.

According to at least one embodiment, bifurcations in carriageway markings ahead of and/or to the rear of the vehicle are employed for executing a distinction between an intentional or conscious lane change and an unintentional or unconscious lane change. The driving assistance system controls the at least one vehicle function such as, for example, a lane departure warning system, on the basis of this distinction such that, for example, hazard warnings and/or interventions in steering which are disturbing to the driver can be prevented. In practice, reliability of the driving assistance system can be improved and road traffic safety enhanced, on the grounds that the driver is not incited to switch off the system on the grounds of unwanted interventions.

The detection module and/or the analysis module and/or the at least one control module can be embodied in a common software and/or hardware module. Alternatively, the detection module and/or the analysis module and/or the at least one control module can be respectively embodied in separate software and/or hardware modules.

The detection module of the driving assistance system is designed to detect a driver-initiated lane change. The lane change can be initiated, for example, by a manual action of the driver, in particular by a steering movement away from the ego-lane.

The detection module preferably employs environmental data from the environmental sensor system. The environmental sensor system can comprise, for example, at least one camera, in particular at least one exterior camera. The detection module can analyze image data which is supplied by the at least one camera, in order to detect the driver-initiated lane change. For example, carriageway markings can be detected in image data wherein, from a horizontal alteration in the position of carriageway markings, it can be concluded that a lane change has been executed or initiated.

However, the present disclosure is not limited to cameras and, additionally or alternatively, environmental data from at least one infrared sensor and/or from a LiDAR system can be employed for detecting the driver-initiated lane change. For example, at least one infrared sensor can be arranged on an underfloor of the vehicle, which sensor detects whether the vehicle is travelling over a carriageway marking. It can be concluded herefrom that a lane change has been executed or initiated.

The detection module, supplementarily to environmental data, can optionally employ further information for detecting the driver-initiated lane change such as, for example, a steering angle, digital map data, a vehicle position, etc.

The analysis module employs environmental data from the environmental sensor system in order to detect bifurcations in carriageway markings ahead of and/or to the rear of the vehicle. The environmental sensor system can comprise, for example, at least one camera, in particular at least one exterior camera. The analysis module can analyze image data which are supplied by the at least one camera in order to detect bifurcations in carriageway markings. For example, by means of a trained detection algorithm, carriageway markings can be identified in image data, and bifurcations identified from the profile thereof.

However, the present disclosure is not limited to cameras and, additionally or alternatively, environmental data from at least one infrared sensor and/or from a LiDAR system can be employed for detecting bifurcations in carriageway markings.

The analysis module, supplementarily to environmental data, can optionally employ further information for detecting bifurcations in carriageway markings such as, for example, digital map data.

The term “bifurcation”, as employed in the context of the present disclosure, refers to a division and/or convergence of lane lines at a given point. Division and convergence are defined on the basis of a direction of travel in a lane and/or a direction of travel of the vehicle.

According to some embodiments, the at least one bifurcation can comprise a lane line convergence. At the lane line convergence, two lane lines meet at a point of convergence, from which only a single lane line continues.

Additionally or alternatively, the at least one bifurcation can comprise a lane line division. At the lane line division, a single lane line terminates at a point of division, from which two lane lines continue.

On the basis of the presence of bifurcations of this type, a categorization of the lane change thus detected as either an intentional lane change or an unintentional lane change is executed.

The term “categorization”, as employed in the context of the present disclosure, describes an assignment of the lane change to the predefined categories “intentional lane change” and “unintentional lane change”, on the basis of a presence of bifurcations in a carriageway marking and, optionally, on the basis of further factors.

Categorization can be executed by means of a software, which software processes input data (i.e. environmental data from the environmental sensor system and, optionally, further data, such as e.g. map data) during the actual operation of the vehicle, in order to detect whether the lane change detected is an intentional or conscious lane change, or an unintentional or unconscious lane change. For example, by means of a detection algorithm, carriageway markings and, from the profile thereof, bifurcations can be identified from environmental data and employed for categorization.

The analysis module is preferably designed for further determining the categorization of the lane change thus detected on the basis of at least one line type which comprises the at least one bifurcation. The at least one line type can comprise a solid line and a broken line. Each bifurcation can comprise two or more different line types. The line type provides indications as to whether a lane change is intentional or otherwise. For example, in the event of the detection of a bifurcation incorporating a broken line, the crossing of which is generally permitted, this can be indicative of an intentional lane change.

The analysis module is preferably designed to categorize the lane change thus detected as an intentional lane change, in the event that at least one lane line division is detected within a specific region ahead of the vehicle (e.g. x meters) and/or to the rear of the vehicle (e.g. y meters). This can occur, for example, in conjunction with an exit, such that a corresponding lane line division within a specific region ahead of and/or to the rear of the vehicle can be interpreted as an indication of an intentional lane change associated with the exit.

According to some embodiments, the analysis module is designed to categorize the lane change thus detected as an intentional lane change, in the event that a first lane line division is detected and the first lane line division, subsequently to a point of division, comprises a broken line. Optionally, the first lane line division, ahead of the point of division, can comprise a solid line. A broken line subsequently to the point of division can indicate, for example, the commencement of an exit.

Optionally, the analysis module can be designed to categorize the lane change thus detected as an intentional lane change in the event that, additionally to the first lane line division, a second lane line division is detected, which lane line division is spaced from the first lane line division in the direction of travel. The second lane line division, ahead of a point of division, can comprise a broken line, and optionally, subsequently to the point of division, can comprise a solid line. The solid line subsequently to the point of division can indicate, for example, the completion of an exit.

According to some embodiments, the first lane line division and the second lane line division can be connected by a broken line which separates, for example, an exit from a carriageway lane.

The driver-initiated lane change can thus be executed between the first lane line division and the second lane line division, i.e. at the time of detection of the driver-initiated lane change, the first lane line division is positioned to the rear of the vehicle and the second lane line division is positioned ahead of the vehicle. However, the present disclosure is not limited hereto, and both the first lane line division and the second lane line division, at the time of detection of the driver-initiated lane change, can be positioned ahead of the vehicle, for example in the event that the driver crosses a solid line ahead of an exit, in order to reach the exit earlier. In this case, the lane change can also be categorized as an intentional lane change.

The analysis module is preferably designed to categorize the lane change thus detected as an intentional lane change, in the event that at least one lane line convergence is detected within a specific region ahead of the vehicle (e.g. x meters) and/or to the rear of the vehicle (e.g. y meters). This can occur, for example, in conjunction with a slip road, such that a corresponding lane line convergence within a specific region ahead of and/or to the rear of the vehicle can be interpreted as an indication of an intentional lane change from the slip road e.g. to a freeway lane.

According to some embodiments, the analysis module is designed to categorize the lane change thus detected as an intentional lane change, in the event that a first lane line convergence is detected and the first lane line convergence, subsequently to a point of convergence, comprises a broken line. Optionally, the first lane line convergence, ahead of the point of convergence, can comprise a solid line. A broken line subsequently to the point of convergence can indicate, for example, the delimitation of an entry to a freeway lane.

Optionally, the analysis module can be designed to categorize the lane change thus detected as an intentional lane change in the event that, additionally to the first lane line convergence, a second lane line convergence is detected, which lane line convergence is spaced from the first lane line convergence in the direction of travel. The second lane line convergence, ahead of a point of convergence, can comprise a broken line, and optionally, subsequently to the point of convergence, can comprise a solid line.

According to some embodiments, the first lane line convergence and the second lane line convergence can be connected by a broken line which separates, for example, an entry from a freeway lane.

The driver-initiated lane change can thus be executed between the first lane line convergence and the second lane line convergence, i.e. at the time of detection of the driver-initiated lane change, the first lane line convergence is positioned to the rear of the vehicle and the second lane line convergence is positioned ahead of the vehicle.

However, the present disclosure is not limited hereto, and both the first lane line convergence and the second lane line convergence, at the time of detection of the driver-initiated lane change, can be positioned ahead of the vehicle, for example in the event that the driver crosses a solid line, in order to execute an earlier merging from an entry onto a freeway. In this case, the lane change can also be categorized as an intentional lane change. In a similar manner, both the first lane line convergence and the second lane line convergence, at the time of detection of the driver-initiated lane change, can be positioned to the rear of the vehicle, for example in the event that the driver crosses a solid line, on the grounds that the merging thereof from an entry onto the freeway does not occur until after the entry has passed. In this case, the lane change can also be categorized as an intentional lane change.

The analysis module is preferably designed to categorize the lane change thus detected as an unintentional lane change, in the event that no bifurcation of a carriageway marking is detected in a region ahead of the vehicle.

The analysis module is preferably designed to further execute the categorization of the lane change thus detected on the basis of a steering torque. For example, a temporal variation and/or a magnitude of a steering torque applied by the driver can provide an indication as to whether the lane change initiated is intentional or unintentional.

Additionally or alternatively, the analysis module is designed to further execute the categorization of the lane change thus detected on the basis of a steering angle. For example, a temporal variation and/or a magnitude of a steering angle applied by the driver can provide an indication as to whether the lane change initiated is intentional or unintentional. The steering angle can correspond to a steering wheel position, and thus to a position of the front wheels in relation to a longitudinal axis of the vehicle.

Additionally or alternatively, the analysis module is designed to further execute the categorization of the lane change thus detected on the basis of a pedal setting, in particular on the basis of a drive pedal setting and/or a brake pedal setting. For example, an abrupt and substantial actuation of the brake pedal can provide an indication to the effect that the lane change is intentional. In the event that, however, an accelerator pedal setting remains unchanged or constant, this can be an indication to the effect that the lane change is unintentional.

Additionally or alternatively, the analysis module is designed to further execute the categorization of the lane change thus detected on the basis of lane information. For example, by means of an environmental sensor system of the vehicle, it can be detected that a hard shoulder is present in proximity to the ego-lane, which presence can be an indication to the effect that the lane change initiated is unintentional.

Additionally or alternatively, the analysis module can be designed to further execute the categorization of the lane change thus detected on the basis of (digital) map information. For example, map information can indicate that a hard shoulder is present in proximity to the ego-lane, which presence can be an indication to the effect that the lane change initiated is unintentional.

Additionally or alternatively, the analysis module is designed to further execute the categorization of the lane change thus detected on the basis of driver attentiveness.

For example, the driver can be monitored by means of the interior sensor system such as, for example, an interior camera and/or an interior microphone. If it proceeds from an analysis of monitoring data that the driver is inattentive, this can be an indication to the effect that the lane change initiated is unintentional. If, by contrast, it proceeds from the analysis of monitoring data that the driver is attentive, this can be an indication to the effect that the lane change initiated is intentional.

Additionally or alternatively, the analysis module is designed to further execute the categorization of the lane change thus detected on the basis of environmental information, in particular with respect to at least one other road user. In the event that, for example, it is detected that another vehicle is present in an adjacent lane, which vehicle outputs light signals and/or an acoustic signal (e.g. a horn), this can be an indication to the effect that the lane change initiated is unintentional.

The at least one control module is preferably designed to actuate the at least one vehicle function such that an acoustic and/or optical and/or haptic warning is generated for the attention of the driver, in the event that the lane change detected by the analysis module is categorized as an unintentional lane change. This warning is a signal to the driver of a departure from the ego-lane. The acoustic warning, for example, can be output for the attention of the driver by means of at least one interior loudspeaker. The optical warning, for example, can be output for the attention of the driver by means of at least one display device such as, for example, a central information output device of an infotainment system (e.g. a head unit or pillar-to-pillar display). The haptic warning, for example, can be output for the attention of the driver by means of a vibration of the steering wheel.

The at least one control module is preferably designed to actuate the at least one vehicle function such that a steering system of the vehicle executes an active intervention, in the event that the lane change detected by the analysis module is categorized as an unintentional lane change, in order to prevent a departure from a current lane, and to direct the vehicle back to the current lane. In particular, counter-steering can be initiated, in order to prevent the departure of the vehicle from the ego lane.

The at least one control module is preferably designed to actuate the at least one vehicle function such that the lane change is enabled with no countermeasures on the part of the driving assistance system, in the event that the lane change thus detected is categorized by the analysis module as an intentional lane change. For example, it is possible for no active counter-steering to be executed by the steering system, in the event that the lane change thus detected is categorized by the analysis module as an intentional lane change.

The at least one control module is preferably designed to actuate the at least one vehicle function such that the lane change is actively and/or passively supported by the driving assistance system, in the event that the lane change detected by the analysis module is categorized as an intentional lane change. Active support can comprise, for example, a co-steering executed by the steering system, such that the vehicle executes a change from the ego-lane to an adjacent lane with an optimum trajectory. Passive support can comprise, for example, an omission of measures which inhibit the lane change such as, for example, the execution of counter-steering by the steering system.

The at least one control module is preferably designed to actuate the at least one vehicle function such that a direction of travel indicator is activated, in the event that the lane change thus detected is categorized by the analysis module as an intentional lane change. The lane change can thus be signaled to the exterior, thereby enabling an enhancement of road traffic safety.

According to a further independent aspect of the present disclosure, a vehicle, in particular a motor vehicle, is specified. The vehicle incorporates the driving assistance system according to embodiments of the present disclosure.

The term “vehicle” includes passenger cars, heavy goods vehicles, buses, motorhomes, motorcycles, etc., which are employed for the conveyance of persons, goods, etc. In particular, this term includes motor vehicles for the conveyance of persons.

According to some embodiments, the driving assistance system can comprise a lane departure warning system such as, for example, a passive lane departure warning system or an active lane departure warning system. The passive lane departure warning system alerts the driver to the departure of the vehicle from the ego-lane. The active lane departure warning system can execute interventions in steering, in order to maintain the vehicle in the ego-lane. In other words, an automated lateral control can be executed by the driving assistance system.

According to a further independent aspect of the present disclosure, a driving assistance method for a vehicle, in particular for a motor vehicle, is specified. The driving assistance method comprises a detection by the vehicle of a driver-initiated lane change; a capture of environmental data by an environmental sensor system of the vehicle, wherein environmental data depict an environment of the vehicle; a determination, by means of an analysis of environmental data, as to whether a bifurcation in a carriageway marking is present ahead of and/or to the rear of the vehicle; an execution by the vehicle of a categorization of the lane change thus detected as an intentional lane change or an unintentional lane change on the basis of a presence of the at least one bifurcation ahead of and/or to the rear of the vehicle; and an actuation of at least one vehicle function on the basis of the categorization of the lane change.

The driving assistance method can implement aspects of the driving assistance system described herein.

According to at least one embodiment, a software (SW) program is specified. The SW program can be designed for the execution thereof on one or more processors, in order to execute the driving assistance method described in the present document.

According to at least one embodiment, a storage medium is specified. The storage medium can comprise a SW program, which program is designed for the execution thereof on one or more processors, in order to execute the driving assistance method described in the present document.

According to at least one embodiment, a software having program code is specified. The software is designed for executing the driving assistance method, in the event that the software is run on one or more software-controlled devices.

According to at least one embodiment, a driving assistance system for a vehicle is specified. The driving assistance system comprises one or more processors; and at least one memory, which memory is connected to the one or more processors and contains instructions which can be executed by the one or more processors in order to execute the driving assistance method described herein.

A processor or processor module is a programmable computing device, and thus a machine or an electronic circuit, which device, in accordance with commands transmitted, controls other elements and thus drives an algorithm (process).

Exemplary embodiments of the disclosure are represented in the figures, and are described in greater detail hereinafter.

### BRIEF DESCRIPTION OF THE DRAWINGS

FIG. 1 shows a schematic representation of a vehicle having a driving assistance system according to embodiments of the present disclosure;

FIG. 2 shows a schematic representation of a vehicle which is executing a lane change at an exit, according to embodiments of the present disclosure;

FIG. 3 shows a schematic representation of a vehicle which is executing a lane change from an entry to a freeway, according to embodiments of the present disclosure;

FIG. 4 shows a flow diagram of a driving assistance method for a vehicle, according to embodiments of the present disclosure.

### DETAILED DESCRIPTION OF THE DRAWINGS

Hereinafter, unless indicated otherwise, the same reference symbols are employed for identical and identically functioning elements.

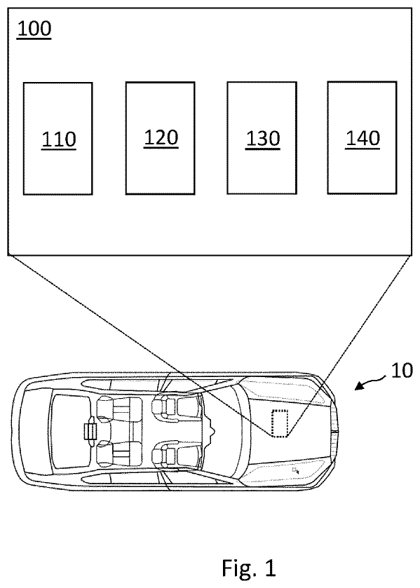

FIG. 1 shows a schematic representation of a vehicle 10 having a driving assistance system 100 according to embodiments of the present disclosure.

The driving assistance system 100 comprises a detection module 110 which is designed to detect a driver-initiated lane change; an environmental sensor system 120 which is designed to capture environmental data, wherein environmental data depict an environment of the vehicle 10; an analysis module 130 which is designed for analyzing environmental data, in order to identify bifurcations in a carriageway marking ahead of and/or the rear of the vehicle 10, wherein the analysis module 130 is further designed, on the basis of a presence of at least one bifurcation in a carriageway marking ahead of and/or to the rear of the vehicle 10, to execute a categorization of the lane change thus detected as an intentional (or conscious) lane change or an unintentional (or unconscious) lane change; and at least one control module 140 which is designed to actuate at least one vehicle function on the basis of the categorization of the lane change thus detected.

According to some embodiments, the driving assistance system 100 can comprise a lane departure warning system such as, for example, a passive lane departure warning system or an active lane departure warning system. The passive lane departure warning system alerts the driver to the departure of the vehicle 10 from the ego-lane. The active lane departure warning system can execute interventions in steering, in order to maintain the vehicle 10 in the ego-lane. In other words, an automated lateral control can be executed by the driving assistance system 100.

The detection module 110 preferably employs data captured by at least one sensor module, in order to detect the driver-initiated lane change. The at least one sensor module, for example, can comprise at least one camera, in particular at least one exterior camera. The detection module 110 can analyze image data which are supplied by the at least one camera, in order to detect the driver-initiated lane change. For example, carriageway markings can be detected in image data wherein, from a horizontal alteration in a position of carriageway markings, it can be concluded that a lane change has been executed or initiated. Optionally, the detection module 110, supplementarily to captured data, can employ further information for the detection of the driver-initiated lane change such as, for example, a steering angle, digital map data, a vehicle position, etc.

The analysis module 130 employs environmental data from the environmental sensor system 120 in order to detect bifurcations in carriageway markings ahead of and/or to the rear of the vehicle 10. The environmental sensor system 120, for example, can comprise at least one camera, in particular at least one exterior camera. The analysis module 130 can analyze image data which are supplied by the at least one camera in order to detect bifurcations in carriageway markings. For example, by means of a trained detection algorithm, carriageway markings can be identified in image data, and bifurcations identified from the profile thereof. However, the present disclosure is not limited to cameras and, additionally or alternatively, environmental data e.g. from at least one infrared sensor and/or from a LiDAR system can be employed for detecting bifurcations in carriageway markings.

The analysis module 130, supplementarily to environmental data, can optionally employ further information for detecting bifurcations in carriageway markings such as, for example, digital map data.

According to some embodiments, the at least one bifurcation comprises a lane line convergence. At the lane line convergence, two lane lines meet at a point of convergence, from which only a single lane line continues. Additionally or alternatively, the at least one bifurcation can comprise a lane line division. At the lane line division, a single lane line terminates at a point of division, from which two lane lines continue.

On the basis of the presence of bifurcations of this type, a categorization of the lane change thus detected as either an intentional lane change or an unintentional lane change is executed.

The at least one control module 140 controls the at least one vehicle function on the basis of the categorization of the lane change. For example, an acoustic and/or optical and/or haptic warning can be output for the attention of the driver and/or a steering system of the vehicle 10 can intervene actively in the control of the vehicle, in the event that the lane change which is detected by the analysis module 130 is categorized as an unintentional lane change. According to a further example, the lane change can be actively and/or passively supported by the driving assistance system 100, in the event that the lane change detected by the analysis module 130 is categorized as an intentional lane change. Active support can comprise, for example, a co-steering executed by the steering system, such that the vehicle 10 executes a change from the ego-lane to the adjacent lane with an optimum trajectory. Passive support can comprise, for example, an omission of measures which inhibit the lane change such as, for example, the execution of counter-steering by the steering system.

According to some embodiments, the at least one control module 140 can be designed to actuate the at least one vehicle function such that a direction of travel indicator or indicator light is activated in the event that the lane change SW which is detected by the analysis module 130 is categorized as an intentional lane change. The lane change SW can thus be signaled externally, as a result of which an enhancement of road traffic safety is enabled.

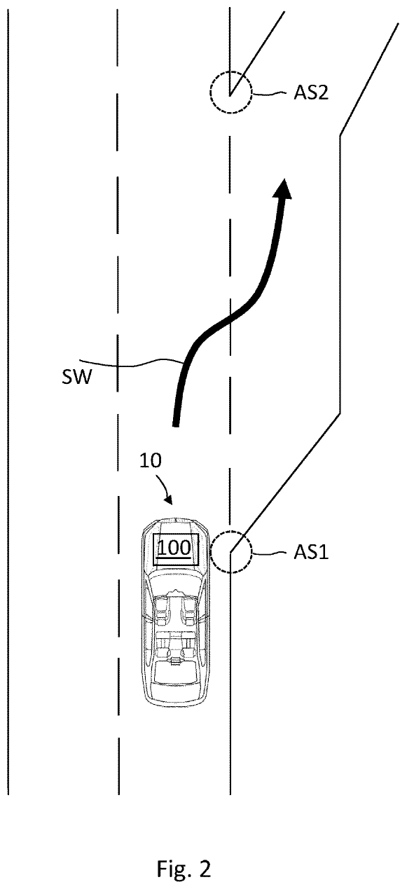

FIG. 2 shows a schematic representation of a vehicle 10 which is executing a lane change SW at an exit, according to embodiments of the present disclosure. FIG. 2 exemplarily represents the manner in which, on the basis of lane line divisions AS1, AS2, a categorization of the lane change SW thus detected as an intentional lane change or an unintentional lane change can be executed.

At the lane line division AS1, AS2, a single lane line terminates at a point of division, from which two lane lines continue. On the basis of a presence of lane line divisions AS1, AS2 of this type, a categorization of the lane change SW thus detected as an intentional lane change or an unintentional lane change can be executed.

According to some embodiments, the driving assistance system is designed to categorize the lane change SW thus detected as an intentional lane change, in the event that a first lane line division AS1 is detected and the first lane line division AS1, subsequently to a point of division, comprises a broken line. Optionally, the first lane line division AS1, ahead of the point of division, can comprise a solid line. The broken line subsequently to the point of division can indicate, for example, the commencement of an exit, as represented in the example according to FIG. 2.

Optionally, the driving assistance system can be designed to categorize the lane change thus detected as an intentional lane change in the event that, additionally to the first lane line division AS1, a second lane line division AS2 is detected, which lane line division is spaced from the first lane line division AS1 in the direction of travel. The second lane line division AS2, ahead of a point of division, can comprise a broken line, and optionally, subsequently to the point of division, can comprise a solid line. The solid line subsequently to the point of division can indicate, for example, the completion of an exit.

The first lane line division AS1 and the second lane line division AS2 can be connected by a broken line which separates, for example, an exit from a freeway lane.

The driver-initiated lane change SW can thus be executed between the first lane line division AS1 and the second lane line division AS2, i.e. at the time of detection of the driver-initiated lane change SW, the first lane line division AS1 is positioned to the rear of the vehicle 10 and the second lane line division AS2 is positioned ahead of the vehicle 10.

With reference to FIG. 2, according to some embodiments, from a specific distance ahead of the first lane line division AS1 (e.g. x meters ahead thereof) up to the first lane line division AS1, no inhibition of the lane departure warning system is executed i.e. the lane departure warning system intervenes, and warns the driver and/or intervenes in the steering system of the vehicle 10, for the maintenance thereof in-lane.

However, the present disclosure is not limited hereto, and both the first lane line division AS1 and the second lane line division AS2, at the time of detection of the driver-initiated lane change SW, can be positioned ahead of the vehicle 10, for example in the event that the driver crosses a solid line ahead of an exit, in order to reach the exit earlier. In this case, the lane change SW can also be categorized as an intentional lane change.

This means that, according to some embodiments, from a specific distance ahead of the first lane line division AS1 (e.g. x meters ahead thereof (e.g. 50 m)) up to the first lane line division AS1, an inhibition of the lane departure warning system is executed, i.e. the lane departure warning system does not intervene, and does not warn the driver and/or intervene in the steering system of the vehicle 10, such that the lane change can be executed with no countermeasures.

In the region between the first lane line division AS1 and the second lane line division AS2, an inhibition of the lane departure warning system can be executed, i.e. the lane departure warning system does not intervene, and does not warn the driver and/or intervene in the steering system of the vehicle 10, such that the lane change can be executed with no countermeasures. For example, within a specific distance subsequently to the first lane line division AS1 (e.g. x meters thereafter (e.g. 250 m)) no inhibition of the lane departure warning system is executed, in the event that a broken line is detected. Additionally or alternatively, within a specific distance ahead of the second lane line division AS2 (e.g. x meters ahead thereof (e.g. 250 m)), no inhibition of the lane departure warning system is executed, in the event that a broken line is detected. The variables x can be selected in accordance with a vehicle speed and/or a length of the exit.

In the region subsequently to the second lane line division AS2, it is possible for no inhibition of the lane departure warning system to be executed, i.e. the lane departure warning system intervenes and warns the driver, and/or intervenes in the steering system of the vehicle 10, particularly in the event that a solid line is detected subsequently to the second lane line division AS2.

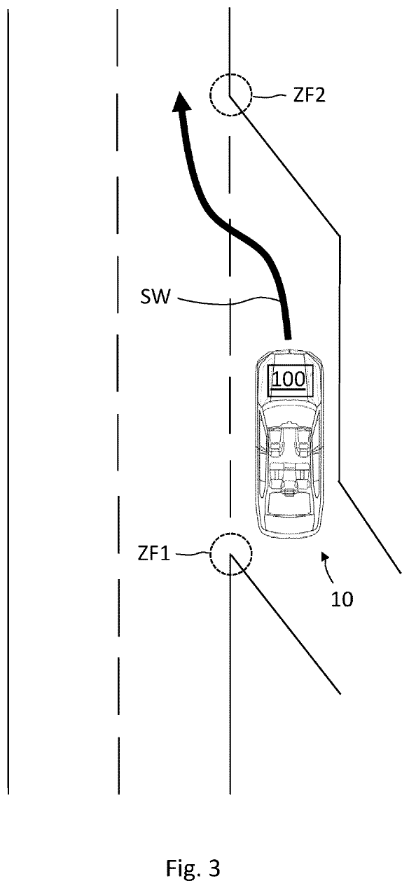

FIG. 3 shows a schematic representation of a vehicle 10 which is executing a lane change SW from an entry to a freeway. FIG. 3 exemplarily represents the manner in which, on the basis of lane line convergences ZF1, ZF2, a categorization of the lane change SW thus detected as an intentional lane change or an unintentional lane change can be executed.

At the lane line convergence ZF1, ZF2, two lane lines terminate at a point of division, from which a single lane line continues. On the basis of a presence of lane line convergences ZF1, ZF2 of this type, a categorization of the lane change SW thus detected as an intentional lane change or an unintentional lane change is executed.

According to some embodiments, the driving assistance system is designed to categorize the lane change SW thus detected as an intentional lane change, in the event that a first lane line convergence ZF1 is detected and the first lane line convergence ZF1, subsequently to a point of division, comprises a broken line. Optionally, the first lane line convergence ZF1, ahead of the point of division, can comprise a solid line. The broken line subsequently to the point of division can, for example, delimit an entry, as represented in the example according to FIG. 3.

Optionally, the driving assistance system can be designed to categorize the lane change thus detected as an intentional lane change in the event that, additionally to the first lane line convergence ZF1, a second lane line convergence ZF2 is detected, which lane line convergence is spaced from the first lane line convergence ZF1 in the direction of travel. The second lane line convergence ZF2, ahead of a point of division, can comprise a broken line, and optionally, subsequently to the point of division, can comprise a solid line.

The first lane line convergence ZF1 and the second lane line convergence ZF2 can be connected by a broken line which separates, for example, an entry to a freeway lane.

The driver-initiated lane change SW can thus be executed between the first lane line convergence ZF1 and the second lane line convergence ZF2, i.e. at the time of detection of the driver-initiated lane change SW, the first lane line convergence ZF1 is positioned to the rear of the vehicle 10 and the second lane line convergence ZF2 is positioned ahead of the vehicle 10.

With reference to FIG. 3, according to some embodiments, from a specific distance ahead of the first lane line convergence ZF1 (e.g. x meters ahead thereof) up to the first lane line convergence AF1, no inhibition of the lane departure warning system is executed i.e. the lane departure warning system intervenes, and warns the driver and/or intervenes in the steering system of the vehicle 10, for the maintenance thereof in-lane.

However, the present disclosure is not limited hereto, and the first lane line convergence ZF1, at the time of detection of the driver-initiated lane change SW, can be positioned ahead of the vehicle 10, for example in the event that the driver crosses a solid line in order to execute an earlier entry to the freeway lane. In this case, the lane change SW can also be categorized as an intentional lane change. This means that, according to some embodiments, from a specific distance ahead of the first lane line convergence ZF1 (e.g. x meters ahead thereof (e.g. 50 m)) up to the first lane line convergence ZF1, an inhibition of the lane departure warning system is executed, i.e. the lane departure warning system does not intervene, and does not warn the driver and/or intervene in the steering system of the vehicle 10, such that the lane change can be executed with no countermeasures.

In the region between the first lane line convergence ZF1 and the second lane line convergence ZF2, an inhibition of the lane departure warning system can be executed, i.e. the lane departure warning system does not intervene, and does not warn the driver and/or intervene in the steering system of the vehicle 10, such that the lane change or the entry to the freeway can be executed with no countermeasures. For example, within a specific distance subsequently to the first lane line convergence ZF1 (e.g. x meters thereafter (e.g. 250 m)) no inhibition of the lane departure warning system is executed, in the event that a broken line is detected. Additionally or alternatively, within a specific distance ahead of the second lane line convergence ZF2 (e.g. x meters ahead thereof (e.g. 250 m)), no inhibition of the lane departure warning system is executed, in the event that a broken line is detected. The variables x can be selected in accordance with a vehicle speed and/or a length of the entry.

In the region subsequently to the second lane line convergence ZF2, it is possible for no inhibition of the lane departure warning system to be executed, i.e. the lane departure warning system intervenes and warns the driver, and/or intervenes in the steering system of the vehicle 10, particularly in the event that a solid line is detected subsequently to the second lane line convergence ZF2.

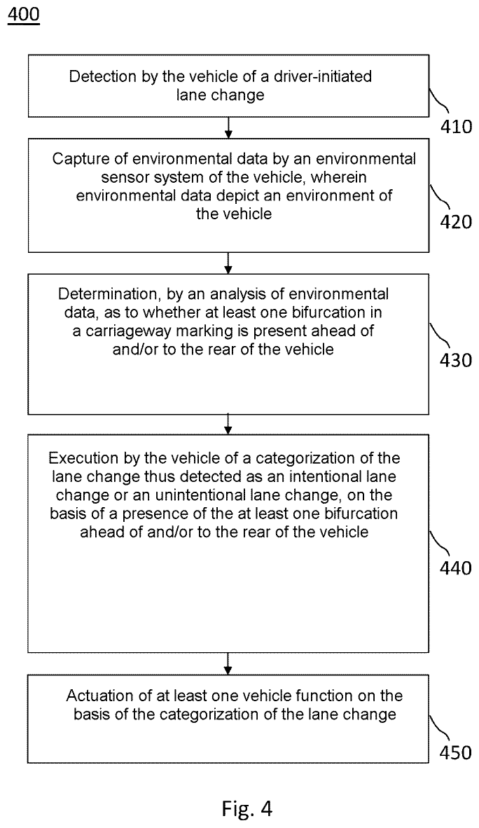

FIG. 4 shows a schematic representation of a driving assistance method 400 for a vehicle, according to embodiments of the present disclosure. The driving assistance method 400 can be implemented by means of a corresponding software, which software is executable by means of one or more processors (e.g. a CPU).

The driving assistance method 400 comprises, in block 410, a detection of a driver-initiated lane change by the vehicle; in block 420, a capture of environmental data by an environmental sensor system of the vehicle, wherein the environmental data depict an environment of the vehicle; in block 430, a determination, by means of an analysis of environmental data, as to whether at least one bifurcation in a carriageway marking is present ahead of and/or to the rear of the vehicle; in block 440, an execution by the vehicle of a categorization of the lane change thus detected as an intentional lane change or an unintentional lane change, on the basis of a presence of the at least one bifurcation ahead of and/or to the rear of the vehicle; and, in block 450, an actuation of at least one vehicle function on the basis of the categorization of the lane change.

According to the invention, bifurcations in carriageway markings ahead of and/or to the rear of the vehicle are detected and employed for the execution of a distinction between an intentional or conscious lane change, and an unintentional or unconscious lane change. The driving assistance system actuates the at least one vehicle function, such as, for example, a lane departure warning function, on the basis of this distinction such that, for example, hazard warnings and/or interventions in steering which are disturbing to the driver can be prevented. In consequence, a reliability of the driving assistance system can be improved, and an enhancement of road traffic safety enabled, as the driver is not induced to switch off the system on the grounds of unwanted interventions.

Although the invention has been illustrated and explained in greater detail with reference to preferred exemplary embodiments, the invention is not limited by the examples disclosed, and further variations can be inferred herefrom by a person skilled in the art, without departing from the protective scope of the invention. It is therefore clear that a multiplicity of potential variations exist. It is also clear that exemplary embodiments specified, in practice, represent examples only, which examples are not to be considered, in any way, as equivalent to any limitation of the protective scope, options for application or the configuration of the invention. Instead, the preceding description and the description of the figures enable the practical implementation of exemplary embodiments by a person skilled in the art, wherein the person skilled in the art, in the knowledge of the concept of the invention disclosed, is enabled to execute numerous variations, for example with respect to the function or the arrangement of individual elements which are specified in an exemplary embodiment, without departing from the scope of protection, which scope is defined by the claims and by legal equivalences thereof such as, for example, further explanations which are included in the description.

1-10. (canceled)

11. A driving assistance system for a vehicle, comprising:
a detection module configured to detect a driver-initiated lane change;
an environmental sensor system configured to capture environmental data depicting an environment of the vehicle;
an analysis module configured to:
analyze the environmental data so as to detect at least one bifurcation in a carriageway marking ahead of and/or to rear of the vehicle,
categorize the lane change as intentional or as unintentional based on the detection of at least one bifurcation; and
a control module configured to actuate at least one vehicle function based on the categorization of the lane change.

12. The driving assistance system of claim 11, wherein the lane change is categorized based on at least one line type which comprises the at least one bifurcation, wherein the at least one line type includes: a solid line and/or a broken line.

13. The driving assistance system of claim 11, wherein the at least one bifurcation comprises a lane line division and/or a lane-line convergence.

14. The driving assistance system of claim 13, wherein the lane change is categorized as intentional when:
at least one lane line division is detected within a region ahead of and/or to the rear of the vehicle; and/or
at least one lane line convergence is detected within a region ahead of and/or to the rear of the vehicle.

15. The driving assistance system of claim 14, wherein the lane change is categorized as intentional when:
a first lane line division is detected that, subsequently to a point of division, comprises a broken line, and a second lane line division is detected spaced from the first lane line division in the direction of travel; and/or
a first lane line convergence is detected that, subsequently to a point of convergence, comprises a broken line, and a second lane line convergence is detected spaced from the first lane line convergence.

16. The driving assistance system of claim 11, wherein lane change is categorized as unintentional when no bifurcation is detected in a region ahead of the vehicle.

17. The driving assistance system of claim 11, wherein the at least one vehicle function is actuated such that:
an acoustic and/or optical and/or haptic warning is generated for the attention of the driver when the lane change is categorized as unintentional;
a steering system of the vehicle executes an active intervention so as to prevent a departure from a current lane and to direct the vehicle back to the current lane when the lane change is categorized as unintentional;
the lane change is enabled with no countermeasures on the part of the driving assistance system when the lane change is categorized as intentional;
the lane change is actively and/or passively supported by the driving assistance system when the lane change is categorized as intentional; and/or
a direction of travel indicator is activated when the lane change is categorized as intentional.

18. A motor vehicle comprising the driving assistance system of claim 11.

19. A driving assistance method for a vehicle, comprising:
detecting a driver-initiated lane change by the vehicle;
capturing environmental data via an environmental sensor system of the vehicle, wherein the environmental data depicts an environment of the vehicle;
determining, via analyzing the environmental data, whether at least one bifurcation in a carriageway marking is present ahead of and/or to the rear of the vehicle;
categorizing the lane change as intentional or as unintentional based on determining the presence of at least one bifurcation ahead of and/or to the rear of the vehicle; and
actuating at least one vehicle function based on the categorization of the lane change.

20. A non-transitory storage medium comprising a software program executable by one or more processors to carry out the driving assistance method of claim 19.
